(19) United States
(12) Patent Application Publication
(10) Pub. No.: US 2012/0032963 A1
(43) Pub. Date: Feb. 9, 2012

(54) DISPLAY APPARATUS AND FRAME TO ACCOMMODATE DISPLAY PANEL

(75) Inventors: S-ru KIM, Anyang-si (KR); Jin-hyun CHO, Seoul (KR)

(73) Assignee: SAMSUNG ELECTRONICS CO., LTD., Suwon-si (KR)

(21) Appl. No.: 13/173,425

(22) Filed: Jun. 30, 2011

(30) Foreign Application Priority Data
Aug. 9, 2010 (KR) 10-2010-0076530
Mar. 9, 2011 (KR) 10-2011-0020702

(51) Int. Cl. G06T 1/00; F21V 7/22

(52) U.S. Cl. 345/501; 362/611

(57) ABSTRACT

A display apparatus including: a frame to accommodate a display panel, is provided. The display apparatus includes a display panel which displays an image based on an image signal; a main frame which includes a first frame supporting a front side of the display panel and a second frame supporting a rear side of the display panel. A sub-frame is coupled to the main frame, and a light source module is disposed behind the display panel and provides light to the display panel. At least one of the first frame, the second frame and the sub-frame, where the light source module is supported, has smaller thermal expansivity than the others of the first frame, the second frame and the sub-frame, where the light source module is not supported.

### CROSS-REFERENCE TO RELATED APPLICATION

This application claims priority from Korean Patent Applications No. 10-2010-0076530, filed on Aug. 9, 2010 and No. 10-2011-0020702, filed on Mar. 9, 2011 in the Korean Intellectual Property Office, the disclosure of which is incorporated herein by reference.

### BACKGROUND

1. Field

Apparatuses consistent with the exemplary embodiments relate to a display apparatus to display an image on a display panel, and more particularly, to a display apparatus in which a frame to accommodate a display panel has an improved structure.

2. Description of the Related Art

A display apparatus is a device which includes a display panel to display an image and displays various formats of image data, and may be realized as a television (TV), a monitor, and the like. The display panel may be provided in various forms depending on characteristics thereof, such as a liquid crystal display and a plasma display panel, and may be applied to a variety of display apparatuses. Here, when the display panel is a liquid crystal display which does not generate light by itself, the display apparatus includes a light source to generate light to be provided to the display panel.

The display apparatus employs a light emitting diode (LED) having excellent environmental characteristics and response speed as a light source as compared with a cold cathode fluorescent lamp used in the related art. The display apparatus is classified as a direct type display apparatus and an edge type display apparatus depending on a relative location of a light source to a light guide plate.

Meanwhile, with the development of technology, the demand of users, etc., there is a growing trend toward a slim structure for the display apparatus. However, if the thickness of the display apparatus is decreased, the display apparatus has a low strength and is vulnerable to thermal deformation due to heat generated from the light source. That is, the display apparatus may become twisted due to thermal deformation while being used. Thus, in light of keeping the display panel flat, it is important to prevent the slim structure of the display apparatus from being deformed by heat generated from the light source.

### SUMMARY

Accordingly, one or more exemplary embodiments provide a display apparatus in which a frame to accommodate a display panel has an improved structure.

The foregoing and/or other aspects may be achieved by providing a display apparatus including: a display panel which displays an image based on an image signal; a main frame which includes a first frame supporting a front side of the display panel and a second frame supporting a rear side of the display panel; a sub-frame which is coupled to the main frame; and a light source module which is disposed behind the display panel and provides light to the display panel, wherein at least one of the first frame, the second frame and the sub-frame, where the light source module is supported, has smaller thermal expansivity than the others of the first frame, the second frame and the sub-frame, where the light source module is not supported.

The first frame, the second frame and the sub-frame may be thermally deformed by heat from the light source module to correspond to one another while the light source module operates.

The sub-frame may be accommodated in, and interposed between, the first frame and the second frame.

The sub-frame may be supported by at least one of the first frame and the second frame.

The sub-frame may be shaped like a bar having a polygonal cross-section, and may include a first surface contacting the first frame, a second surface arranged in a reverse manner to the first surface and contacting the second frame, and a third surface interposed between the first surface and the second surface and contacting the light source module.

At least one of the first surface and the second surface of the sub frame may be coupled to at least one of the first frame and the second frame by at least one of a fastener, a double-sided tape and an adhesive.

The first frame may have a rectangular or circular shape extending along four edges—top, bottom, right, and left edges of the display panel, and the sub-frame may have a bar shape extending along the first frame.

If the light source modules are supported by one of the sub-frame and the second frame, the frame supporting the light source module may have smaller thermal expansivity than the other frame which does not support the light source module, and the thermal expansivity of the other frame which does not support the light source module may be smaller than the thermal expansivity of the first frame supporting the light source module.

If the light source modules are respectively supported by the sub-frame and the second frame, the sub-frame and the second frame may have smaller thermal expansivity than the first frame.

The light source module may include a light source and a light source board having one surface on which the light source is mounted, and the other surface supported by at least one of the sub-frame and the second frame.

The display apparatus may further include a base supported on a predetermined installation surface and a stand coupled to the base and supporting the main frame against the base.

The display apparatus may further include: an image signal receiver which receives an image signal; an image signal processor which processes the image signal received by the image signal receiver to be displayed on the display panel; and a light source driver which drives the light source module, wherein at least one of the light source driver, the image signal receiver, and the image signal processor is coupled to at least one of the main frame and the base.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a perspective view of a display apparatus according to a first exemplary embodiment;

FIG. 2 is a lateral cross-sectional view of an area A of the display apparatus of FIG. 1, taken along a line I-I;

FIG. 3 is a lateral cross-sectional view of the display apparatus of FIG. 2 disassembled;

FIG. 4 is a lateral cross-sectional view of a display apparatus according to a second exemplary embodiment;

FIG. 5 is a lateral cross-sectional view of a display apparatus according to a third exemplary embodiment;

FIG. 6 is a lateral cross-sectional view of a display apparatus according to a fourth exemplary embodiment;

FIG. 7 is a lateral cross-sectional view of a display apparatus according to a fifth exemplary embodiment;

FIG. 8 illustrates a configuration of a display apparatus according to a sixth exemplary embodiment;

FIG. 9 is a lateral cross-sectional view of a display apparatus according to a seventh exemplary embodiment; and

FIG. 10 is a lateral cross-sectional view of a display apparatus according to an eighth exemplary embodiment.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout. Exemplary embodiments will be described regarding elements that directly relate to the spirit of the inventive concept, and descriptions of other elements will be omitted. However, it does not mean that the elements whose descriptions are omitted are unnecessary for embodying a display apparatus 1 having the spirit of the inventive concept.

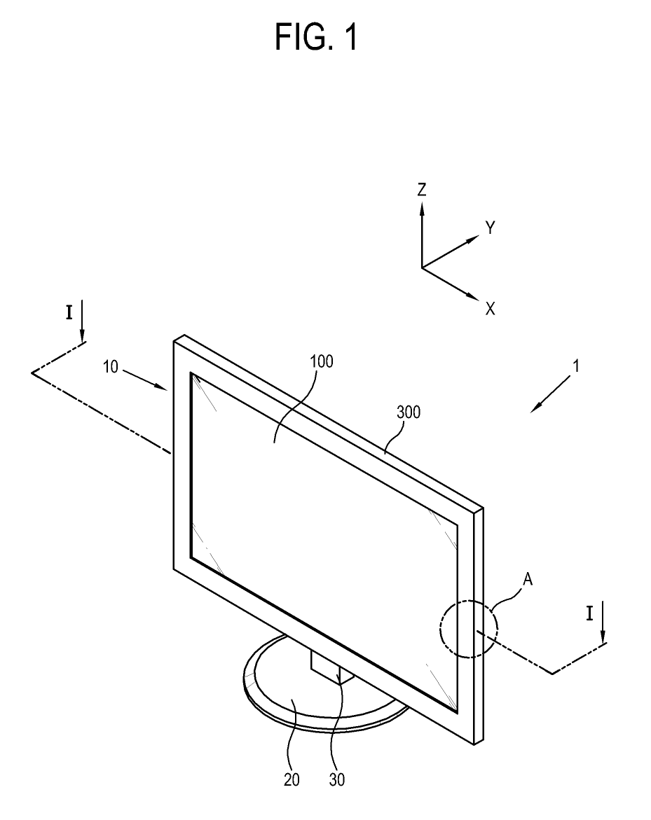

FIG. 1 is a perspective view of a display apparatus 1 according to a first exemplary embodiment.

As shown in FIG. 1, the display apparatus 1 according to the present exemplary embodiment may be configured as a desktop or wall-mountable TV or a computer monitor, but is not limited thereto.

The display apparatus 1 includes a display body 10, a base 20 supported on an installation surface such as the ground, and a stand 30 coupled to the base 20 and supporting the display body 10 against the base 20. In the present exemplary embodiment, the display apparatus 1 includes the base 20 and the stand 30, but is not limited thereto. Alternatively, the display body 10 may be supported on an installation surface such as a wall perpendicular to the ground without the base 20 and the stand 30.

First, directions shown in the drawings are defined. Basically, X, Y and Z directions indicate the width, the length and the height, respectively. When the display body 10 stands erect on the base 20 via the stand 30, the base 20 is disposed on an XY-plane, the stand 30 extends in a z-axis, and the display body 10 is disposed on an XZ-plane. Hereinafter, the drawings and exemplary embodiments will be described based on the above definition. Here, the opposite X, Y and Z directions are expressed as −X, −Y and −Z directions, respectively, and the XY-plane means a plane defined by an x-axis and a y-axis.

The display body 10 includes a display panel 100 having a display region where an image is displayed and a main frame 300 to accommodate the display panel 100 so that the display region is exposed to a viewer facing a front side of the display panel.

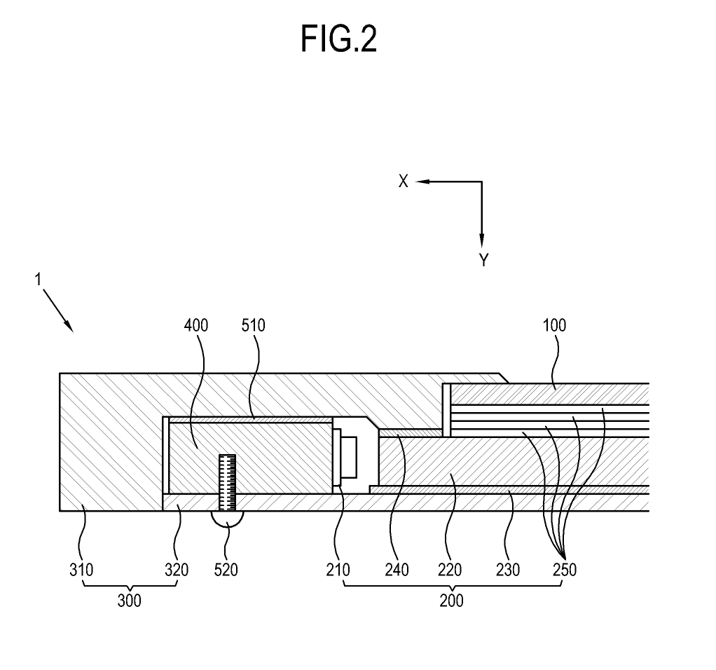

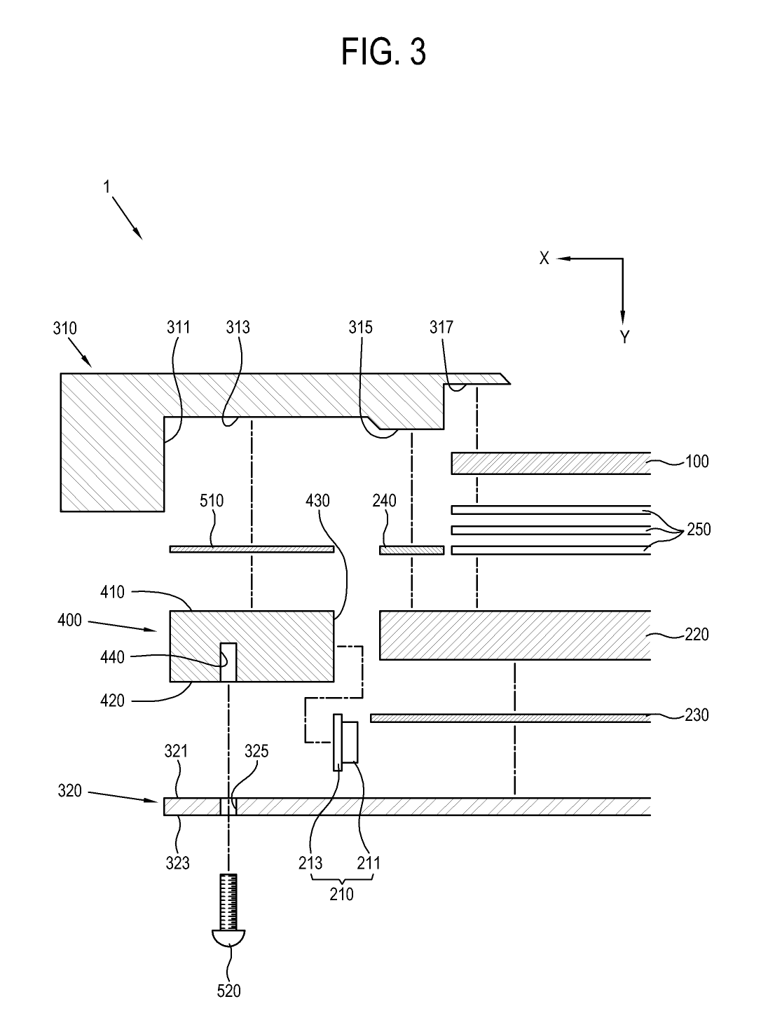

Hereinafter, a configuration of the display body 10 is described further with reference to FIGS. 2 and 3.

FIG. 2 is a lateral cross-sectional view of an area A of the display apparatus 1, as shown in FIG. 1, taken along a line I-I parallel with the x-axis, and FIG. 3 is a lateral cross-sectional view of components shown in FIG. 2 disassembled.

As shown in FIGS. 2 and 3, the display body 10 includes the display panel 100 having the display region where an image is displayed in a front side of the display panel, a backlight unit 200 disposed behind the display panel 100, and the main frame 300 to accommodate the display panel 100 and the backlight unit 200.

In the present exemplary embodiment, the display panel 100 is realized as a liquid crystal panel. The display panel 100 includes two substrates (not shown) and a liquid crystal layer (not shown) interposed therebetween and displays an image, by adjusting the arrangement of liquid crystals in the liquid crystal layer (not shown) by application of a driving signal. The display panel 100 does not emit light by itself and is provided with light from the backlight unit 200 to display an image in the display region.

The backlight unit 200 includes a light source module 210 disposed on an edge area of the display apparatus 1, a light guide plate 220 disposed parallel with the display panel 100 through which light from the light source module 210 enters, a first reflective plate 230 disposed on a lower surface of the light guide plate 220, and optical sheets 250 disposed between the upper surface of the light guide plate 220 and a lower surface of the display panel 100.

At this time, the first reflective plate 230 may be achieved by a separate sheet, and coated with a specific material. Further, a second reflective plate 240 may be disposed on an edge area of an upper surface of the light guide plate 220.

The light source module 210 of the backlight unit 200 in the display apparatus 1 according to an exemplary embodiment, generates light which is provided to the display panel 100. The light source module 210 is disposed on an edge area of the backlight unit 200 to face a lateral side of the light guide plate 220. The light source module 210 is disposed on at least one of two opposite edge areas, or one of long and short side edge areas of the display body 10, which are up, down, right, and left.

The light source module 210 includes a plurality of light sources 211, as shown in FIG. 3, disposed in order along the lateral side of the light guide plate 220 and a light source board 213 on which the light sources 211 are mounted.

In the present exemplary embodiment, the light sources 211 are configured as a light emitting diode (LED) and provided with a driving power and an on and off control signal through the light source board 213. The light sources 211 may include a blue LED, a green LED, and a red LED, and blue light, green light, and red light emitted from the respective colors of LEDs are mixed to generate white light having superior color reproducibility. However, the above configuration is an illustrative example, but the light sources 211 may include a white LED to generate white light.

The light source board 213 extends along an edge area of the display body 10 and is connected to a separate power supply (not shown) to provide power to the light sources 211 mounted thereon. In the present exemplary embodiment, the light source board 213 is disposed to stand erect so that light from the light sources 211 enters the lateral side of the light guide plate 220.

Further, the light source board 213 may be coated with an electric wire pattern layer, or may be formed by a metal board having good thermal conductivity or a flexible printed circuit board (FPCB).

The light guide plate 220 is a plastic lens realized by acryl injection molding and transmits light provided from the light source module 210 uniformly to the entire display region of the display panel 100. In the present exemplary embodiment, the light guide plate 220 may have a size and a shape corresponding to the display panel 100 and is disposed behind the display panel 100.

The light guide plate 220 has a light guide plate pattern or optical pattern formed on the lower surface facing the first reflective plate 230 to diffuse light, thereby improving uniformity of light exiting from the light guide plate 220 and adjusting an amount of exiting light. That is, brightness in the display region may be different depending on how the optical pattern is formed.

The first reflective plate 230 is disposed on the lower surface of the light guide plate 220 and reflects light emitted from the light source module 210 to the light guide plate in a direction of the display panel 100.

The second reflective plate 240 is disposed on the edge area of the upper surface of the light guide plate 220 where the display panel 100 and the optical sheets 250 are not disposed. The second reflective sheet 240 reflects part of light exiting from the light guide plate 220 to the main frame 300 back to the light guide plate 220 so that light from the light source module 210 is guided to the display panel 100.

The optical sheets 250 include at least one sheet disposed parallel with the display panel 100 between the display panel 100 and the light guide plate 220. The optical sheets 250 include a prism sheet, a diffusion sheet, a protection sheet, and the like, and adjust characteristics of light exiting from the light guide plate 220 to be transmitted to the display panel 100.

The main frame 300 accommodates the display panel 100 and the backlight unit 200 therein and supports four edges—top, bottom, right and left edges and a rear side of the display panel 100 and the backlight unit 200.

Here, the display body 10 of the present exemplary embodiment includes a sub-frame 400 coupled in a first region of the main frame 300 and supporting the light source module 210. The sub-frame 400 according to the present exemplary embodiment includes a material having a relatively low thermal expansivity as compared with a thermal expansivity of the first region of the main frame 300.

Accordingly, a phenomenon of minimizing the bending of an edge area of the display body 10 where the light source module 210 is installed occurs. This phenomenon will be described further.

Hereinafter, a configuration of the main frame 300 and the sub-frame 400 is further described.

The main frame 300 includes a front frame 310 to support a front side and a lateral edge of the display panel 100 and the backlight unit 200 so that the display region of the display panel 100 is exposed at a front side of the display panel, and a rear frame 320 to cover the rear side of the display panel 100 and the backlight unit 200.

The front frame 310 and the rear frame 320 are limited in the material of which they are composed, but are composed of substantially the same material. For example, the front frame 310 and the rear frame 320 may include an aluminum material to improve heat radiation of the display apparatus 1 and to contribute to lightness of the display apparatus 1.

The front frame 310 has a rectangular or circular shape extended along four edges—top, bottom, right, and left edges of the display panel 100. The front frame 310 supports the display panel 100 and the backlight unit 200 disposed on the XZ-plane in the X, −X, Z and −Z directions to form an external appearance of the display body 10.

The front frame 310 includes a front frame lateral wall 311 disposed on the four edges of the display panel. Further, the front frame 310 includes a sub-frame supporting part 313 to support the inside sub-frame 400, a second reflective plate supporting part 315 to support the second reflective plate 240, and a panel supporting part 317 to support the display panel 100.

The sub-frame supporting part 313, the second reflective plate supporting part 315, and the panel supporting part 317 are sequentially formed in a direction from the front frame lateral wall 311 to the display panel 100 and have a stepped part to be distinguished from each other. However, the sub-frame supporting part 313, the second reflective plate supporting part 315, and the panel supporting part 317 are named for convenience, and the names, shapes, or figures may not limit the present exemplary embodiment.

The sub-frame supporting part 313 is a portion where the sub-frame 400 is coupled and supported in the front frame 310. In the present exemplary embodiment, the sub-frame 400 is coupled to the sub-frame supporting part 313 using a thermal conductive double-sided tape 510 but may be attached to the sub-frame supporting part 313 using an adhesive. However, the coupling of the sub-frame 400 to the sub-frame supporting part 313 is not limited thereto.

The rear frame 320 covers the rear side of the display panel 100 and the backlight unit 200 is accommodated within the front frame 310 and the rear frame 320. Here, the rear frame 320 of the present exemplary embodiment may be configured as a plate-shaped cover but is not limited thereto. The rear frame 320 may have various shapes.

The rear frame 320 includes an upper surface 321 facing the front frame 310, a lower surface 323 opposite to the upper surface 321, and a first coupling hole 325 formed through the rear frame 320. The sub-frame 400 is coupled on an edge area of the upper surface 321 of the rear frame 320, where the first coupling hole 325 is formed, and the first reflective plate 230 is supported in a center area of the upper surface 321.

The first coupling hole 325 is coupled with a second coupling hole 440 formed in the sub-frame 400 by a fastener 520 so that the sub-frame 400 is coupled to the rear frame 320.

The fastener 520 may use various coupling components such as a screw, a rivet, a clip, but is not limited thereto.

The sub-frame 400 may have a bar shape extending along the front frame 310 and may have a polygonal cross-section. The sub-frame 400 is interposed between the front frame 310 and the rear frame 320. An upper surface 410 of the sub-frame 400 is in contact with, and coupled to, the sub-frame supporting part 313, and a lower surface 420 of the sub-frame 400 is in contact with, and coupled to, the upper surface 321 of the rear frame 320. A lateral side 430 of the sub-frame 400 facing the light guide plate supports the light source module 210, and particularly the light source board 213.

A configuration in which the light source module 210 is supported by the lateral side 430 of the sub-frame 400 may be applied in various forms. For example, a coupling hole (not shown) may be formed in the lateral side 430 to couple the lateral side 430 with the light source board 213 by a fastener (not shown), or the lateral side 430 may be attached to the light source board 213 by using an adhesive or a thermal conductive double-sided tape.

Heat generated from the light source module 210 is first transmitted to the sub-frame 400, and the heat transmitted to the sub-frame 400 is then transmitted to the front frame 310 and the rear frame 320 to be discharged. When temperatures are simultaneously detected in the sub-frame 400, the sub-frame supporting part 313 of the front frame 310, and an edge area of the rear frame 320 while the light source module 210 is driven, the sub-frame 400 has the highest temperature.

In order to compare with the present exemplary embodiment, there is a case where, without the sub-frame 400, the light source module 210 is supported by the front frame 310, and the rear frame 320 is coupled to the front frame 310. A portion of the front frame 310 supporting the light source module 210 has a higher temperature than the rear frame 320, and thus the portion of the front frame 310 has a higher thermal deformation than the rear frame 320 when the front frame 310 and the rear frame 320 have the same thermal expansivity. Thus, the front frame 310 and the rear frame 320 may be bent in an area where the front frame 310 and the rear frame 320 are coupled to each other.

In order to prevent a bending phenomenon, in the present exemplary embodiment, the front frame 310 and the rear frame 320 are respectively coupled to the sub-frame 400, and the sub-frame 400 supports the light source module 210 but has a relatively low thermal expansivity as compared with a thermal expansivity of at least one of the front frame 310 and the rear frame 320. Here, a thermal expansivity of the sub-frame 400 is determined so that the front frame 310, the rear frame 320 and the sub-frame 400 can be deformed to correspond to one another, i.e., substantially equally deformed by heat generated from the light source module 210 when the light source module 210 is driven to operate the light source module 210.

Accordingly, when the sub-frame 400 has a relatively high temperature by heat from the light source module 210, the thermal deformation of the sub-frame 400 becomes substantially the same as the thermal deformation of the front frame 310 or the rear frame 320, the bending phenomenon may be prevented or minimized.

The sub-frame 400 is not limited in material but may include various materials. For example, when the front frame 310 and the rear frame 320 include aluminum, the sub-frame 400 may include steel, stainless steel, copper, and the like. The sub-frame 400 generally includes a higher-strength material than the front frame 310 and the rear frame 320, and thus overall durability of the display apparatus 1 may be improved.

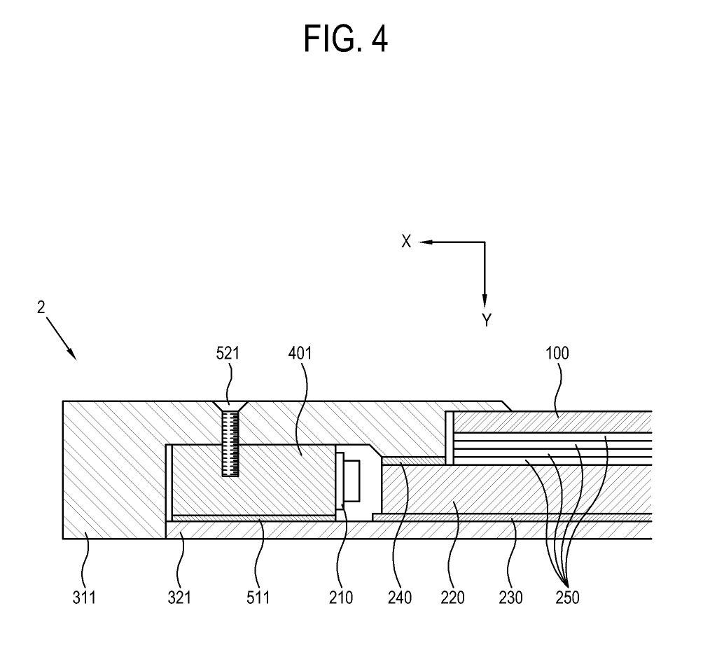

Regarding a coupling component between the sub-frame 400 and the main frame 300 in the first exemplary embodiment, the double-sided tape 510 is used to couple the front frame 310 with the sub-frame 400, and the fastener 520 such as a screw is used to couple the rear frame 320 with the sub-frame 400. However, the coupling component is not limited thereto, and different coupling components from in the first exemplary embodiment are described with reference to FIGS. 4 to 6.

FIG. 4 is a lateral cross-sectional view of a display apparatus 2 according to a second exemplary embodiment.

As shown in FIG. 4, the display apparatus 2 according to the second exemplary embodiment includes a display panel 100, a light source module 210, a light guide plate 220, a first reflective plate 230, a second reflective plate 240, and optical sheets 250. The above components are substantially the same as the components in the first exemplary embodiment, and a description thereof is thus omitted.

The display apparatus 2 includes a front frame 311, a rear frame 321, and a sub-frame 401 interposed between the front frame 311 and the rear frame 321 to support the light source module 210.

Here, the sub-frame 401 is coupled with the front frame 311 by a screw 521 on one side and is attached to the rear frame 321 by a double-sided tape 511 on another side. A coupling hole (not shown) is formed in the sub-frame 401 and the front frame 311 for coupling by the screw 521. The first exemplary embodiment may be applicable to the other components, and a description thereof is thus omitted.

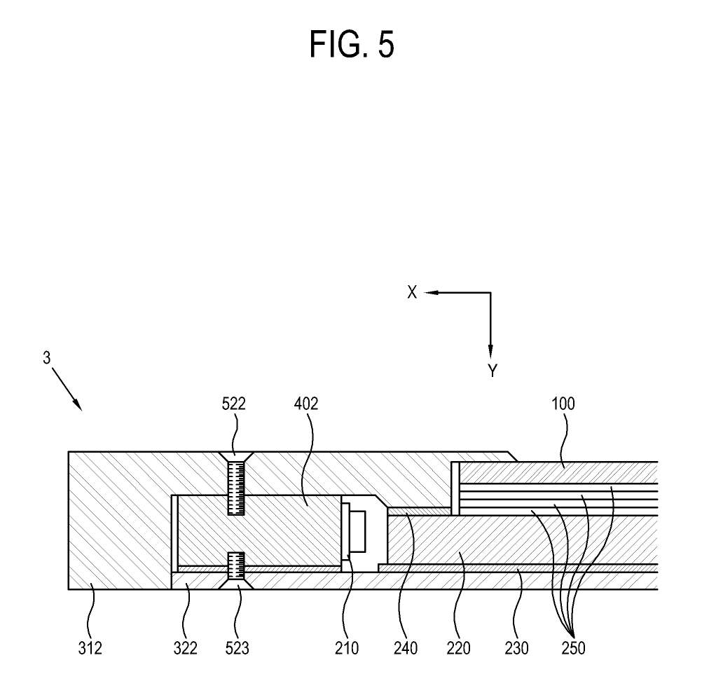

FIG. 5 is a lateral cross-sectional view of a display apparatus 3 according to a third exemplary embodiment.

As shown in FIG. 5, the display apparatus 3 according to the third exemplary embodiment includes a display panel 100, a light source module 210, a light guide plate 220, a first reflective plate 230, a second reflective plate 240, and optical sheets 250. The above components are substantially the same as the components in the first exemplary embodiment, and a description thereof is thus omitted.

The display apparatus 3 includes a front frame 312, a rear frame 322, and a sub-frame 402 interposed between the front frame 312 and the rear frame 322 to support the light source module 210.

Here, the sub-frame 402 is coupled with the front frame 312 by a screw 522 on one side and is coupled with the rear frame 322 by a screw 523 on another side. A coupling hole (not shown) is formed in the sub-frame 402, the front frame 312, and the rear frame 322 for coupling by the screws 522 and 523. The first exemplary embodiment may be applicable to the other components, and a description thereof is thus omitted.

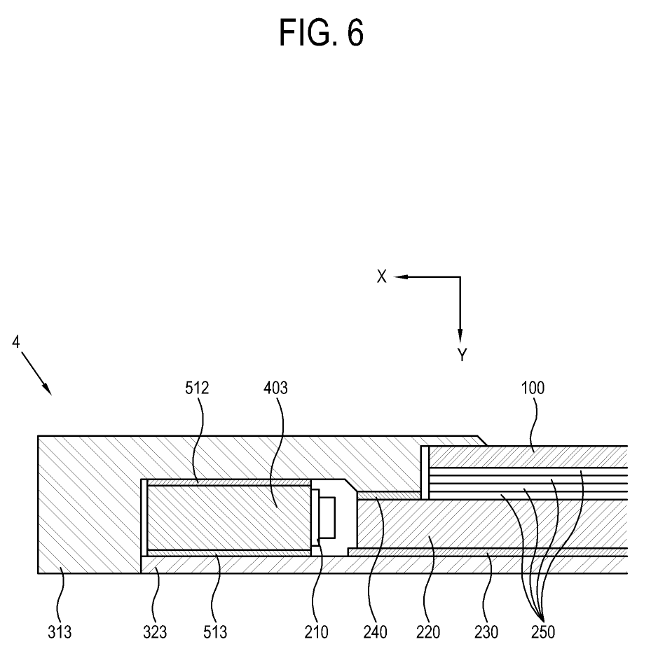

FIG. 6 is a lateral cross-sectional view of a display apparatus 4 according to a fourth exemplary embodiment.

As shown in FIG. 6, the display apparatus 4 according to the fourth exemplary embodiment includes a display panel 100, a light source module 210, a light guide plate 220, a first reflective plate 230, a second reflective plate 240, and optical sheets 250. The above components are substantially the same as the components in the first exemplary embodiment, and thus description thereof is omitted.

The display apparatus 4 includes a front frame 313, a rear frame 323, and a sub-frame 403 interposed between the front frame 313 and the rear frame 323 to support the light source module 210.

Here, the sub-frame 403 is attached to the front frame 313 by a double-sided tape 512 on one side and is attached to the rear frame 323 by a double-sided tape 513 on another side. Alternatively, an adhesive may be used instead of the double-sided tapes 512 and 513. The first exemplary embodiment may be applicable to the other components, and thus description thereof is omitted.

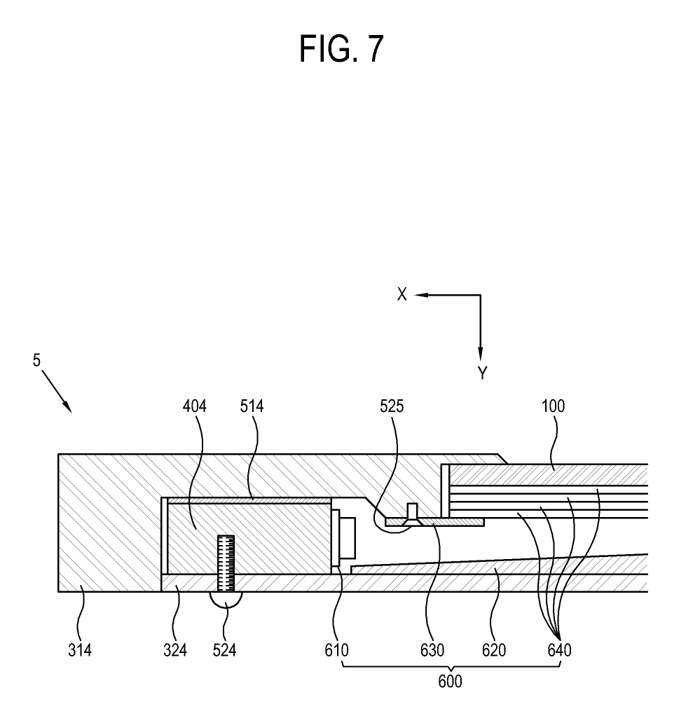

FIG. 7 is a lateral cross-sectional view of a display apparatus 5 according to a fifth exemplary embodiment having a different backlight unit compared to the above exemplary embodiments.

As shown in FIG. 7, the display apparatus 5 according to the fifth exemplary embodiment includes a display panel 100, a backlight unit 600, a front frame 314, a rear frame 324, and a sub-frame 404.

The backlight unit 600 includes a light source module 610 to generate light, a first reflective plate 620 to reflect light emitted from the light source module 610 to the display panel 100, a second reflective plate 630 to reflect light emitted to the front frame 314 toward the first reflective plate 620, and optical sheets 640 to adjust characteristics of light reflected on the first reflective plate 620 to so that light is emitted to the display panel 100. In the present exemplary embodiment, the backlight unit 600 does not include a light guide plate 220.

The sub-frame 404 is disposed between the front frame 314 and the rear frame 324. The sub-frame 404 is attached to the front frame 314 by a double-sided tape 514 on one side, and is coupled to the rear frame 324 by a screw 524 on another side. The first exemplary embodiment may be applicable to the other components, and a description thereof is thus omitted.

The light source module 610 is supported by the sub-frame 404 and emits light to the first reflective plate 620. Although not shown in FIG. 7, a lens to adjust characteristics of light from the light source module 610 may be installed on a light path between the light source module 610 and the first reflective sheet 620.

The first reflective sheet 620 is supported on the rear frame 324 and reflects light from the light source module 610 to the display panel 100. Here, the first reflective plate 620 is formed to slant closer to the display panel 100 as becoming distant from the light source module 610. Strength of light decreases as the distance from the light source module 610 increases, and thus the first reflective plate 620 having the above structure may improve uniformity of overall brightness in a display region.

The second reflective plate 630 reflects light emitted from the light source module 610 to the second reflective plate 630 toward the first reflective plate 620. The second reflective plate 630 may be coupled to the front frame 314 by a screw 525 or the like and may be provided to support the display panel 100 and the optical sheets 640 along with the front frame 314.

The first exemplary embodiment may be applicable to the other components, and a description thereof is thus omitted.

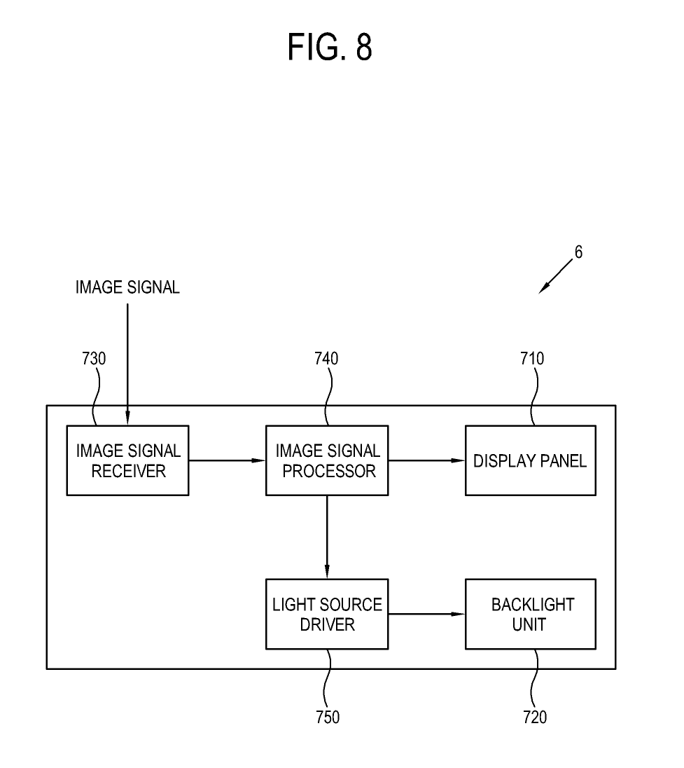

Here, the display apparatuses 1, 2, 3, 4, and 5 according to the above exemplary embodiments receive an image signal from an external source to display an image, which is described in a control configuration with reference to FIG. 8.

FIG. 8 illustrates a configuration of a display apparatus 6 according to a sixth exemplary embodiment.

As shown in FIG. 8, the display apparatus 6 according to the sixth exemplary embodiment includes a display panel 710, a backlight unit 720, an image signal receiver 730 to receive an image signal, an image signal processor 740 to process an image signal received by the image signal receiver 730 to be displayed on the display panel 710, and a light source driver 750 to drive a light source module (not shown) of the backlight unit 720.

The above exemplary embodiments may be applied to the display panel 710 and the backlight unit 720, and a description thereof is thus omitted.

The image signal receiver 730 receives and transmits an image signal to the image signal processor 740, and may be configured in various types corresponding to a standard of a received image signal and a form of the display apparatus 6.

For example, when the display apparatus 6 is a TV, the image signal receiver 730 receives a radio frequency (RF) signal transmitted from a broadcasting station (not shown) by wireless means or image signals in composite video, component video, super video, SCART, and high definition multimedia interface (HDMI) standards through a cable. When an image signal is a broadcasting signal, the image signal receiver 730 includes a tuner to tune the broadcasting signal for each channel.

The image signal processor 740 conducts various preset image processing processes on an image signal. The image signal processor 740 performs the processes to output an image signal to the display panel 710 and controls an operation of the light source driver 750, so that an image is displayed on a display region of the display panel 710.

For example, the image signal processor 740 may conduct, not limited, decoding and encoding corresponding to various image formats, de-interlacing, frame refresh rate conversion, scaling, noise reduction to improve image quality, and detail enhancement. However, the processes performed by the image signal processor are not limited thereto. The image signal processor 740 may be provided as a separate component to independently conduct each process or an integrated component which is multi-functional.

The light source driver 750 controls the turning on and off of the light source module (not shown) of the backlight unit 720 corresponding to a process of the image signal processor 740.

The image signal receiver 730, the image signal processor 740, and the light source driver 750 may be formed on a single or a plurality of printed circuit boards (not shown) to be coupled to the front frame 310 or the rear frame 320 or to be provided in a base 20.

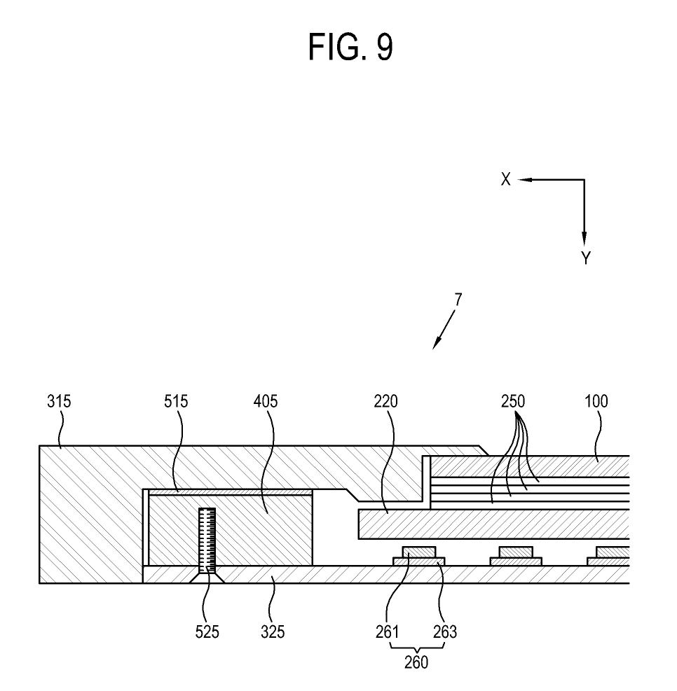

Further, although not shown in FIG. 8, a main frame 300 and a sub-frame 400 having a structure according to the above exemplary embodiments may be applied to the present exemplary embodiment. The above exemplary embodiments may be applied to the main frame 300 and the sub-frame 400, and a description thereof is thus omitted. The foregoing exemplary embodiments disclose the display apparatus 1 having an edge type structure where the light source module 210 is supported by the sub frame 400 and disposed in an edge area of the display apparatus 1, but not limited thereto. Alternatively, the exemplary embodiment may be applied to a display apparatus 7 having a direct type structure where a light source module 260 is supported on the surface of the rear frame 325 facing the display panel 100 and thus is disposed in a parallel manner along a rear side of the display panel 100. With this configuration, a seventh exemplary embodiment will be described with reference to FIG. 9.

FIG. 9 is a lateral cross-sectional view of a display apparatus according to the seventh exemplary embodiment.

As shown in FIG. 9, the display apparatus 7 includes a display panel 100, a light source module 260, a light guide plate 220, and optical sheets 250. Further, the display apparatus 7 includes front and rear frames 315 and 325 respectively supporting and accommodating front and rear sides of the above elements, and a sub-frame 405 interposed between the front and rear frames 315 and 325 and respectively coupled to the front and rear frames 315 and 325. These correspond to those of the foregoing exemplary embodiments, and repetitive descriptions thereof will thus be avoided.

Also, the sub-frame 405 is coupled to the rear frame 325 by a screw 525, and coupled to the front frame 315 by a double-sided tape 515. However, as described in the foregoing exemplary embodiment, a method of coupling the sub frame 405 with the front and rear frames 315 and 325 may be variously determined and applied.

Here, a plurality of light source modules 260 is provided. The plurality of light source modules 260 is disposed in a parallel manner along the rear sides of the display panel 100 and light guide plate 220.

A light source board 263 of each light source module 260 is coupled to or supported on the surface of the rear frame 325 facing the light guide plate 220 and the display panel 100. Further, contrary to the foregoing exemplary embodiments, light generated from a light source 261 on the light source board 263 enters a bottom side of the light guide plate 220, i.e., a surface of the light guide plate 220 in the Y direction, and exits in the −Y direction of the light guide plate 220, thereby entering the display panel 100.

If light is generated in the light source module 260 so that an image can be displayed on the display panel 100, heat generated in the light source module 260 is first transferred to the rear frame 325 since the light source module 260 is supported on the rear frame 325. The heat transferred to the rear frame 325 is transferred again to the front frame 315 and the sub-frame 405.

In other words, if the temperatures of the front frame 315, the rear frame 325 and the sub-frame 405 are simultaneously detected while the light source module 260 operates, the temperature of the rear frame 325 is higher than those of the front frame 315 and sub frame 405.

According to this exemplary embodiment, the thermal expansivity of the rear frame 325 where the light source module 260 is supported is smaller than those of the sub-frame 405 and front frame 315 where the light source module 260 is not supported. Thus, the front frame 315, the rear frame 325 and the sub frame 405 are deformed to correspond to one another by the heat from the light source module 260 while the light source module 260 operates.

More specifically, the quantity of heat involved in the rear frame 325 where the light source module 260 is supported is higher than those of the sub-frame 405 and front frame 315 where the light source module 260 is not supported at a time while the light source module 260 operates.

Accordingly, if the thermal expansivity of the rear frame 325 is relatively lowered, the front frame 315, the rear frame 325 and the sub-frame 405 are deformed to correspond to one another, i.e., are substantially equivalently deformed by the heat from the light source module 260. With this, it is possible to prevent the edge area of the display apparatus 7 from being twisted or bent in the Y or −Y direction with respect to the center area of the display apparatus 7.

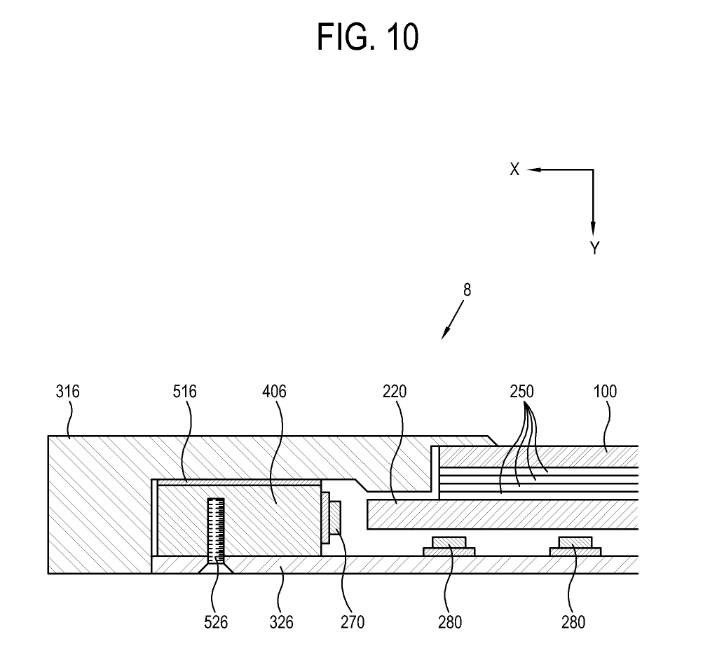

Meanwhile, contrary to the foregoing exemplary embodiments, a display apparatus 8 may be configured as a hybrid type in which a light source module 270, 280 is not supported by only one of a sub-frame 406 and a rear frame 326 but some (270) of plural light source modules 270 and 280 may be supported by the sub-frame 406 and the rest (280) of the light source modules 270, 280 may be supported by the rear frame 326. With this, the display apparatus 8 according to an eighth exemplary embodiment will be described with reference to FIG. 10.

FIG. 10 is a lateral cross-sectional view of a display apparatus according to an eighth exemplary embodiment.

As shown in FIG. 10, the display apparatus 8 includes a display panel 100, a front frame 316, a rear frame 326, a sub-frame 406, light source modules 270 and 280, a light guide plate 220, and optical sheets 250. These correspond to those of the foregoing exemplary embodiments, and repetitive descriptions thereof will thus be avoided.

Also, the sub-frame 406 is coupled to the rear frame 326 by a screw 526, and coupled to the front frame 316 by a double-sided tape 516. However, as described in the foregoing exemplary embodiment, a method of coupling the sub frame 406 with the front and rear frames 316 and 326 may be variously determined and applied.

In this exemplary embodiment, at least light source module 270 among the plural light source modules 270 and 280 may be supported by the sub-frame 406, and the other light source modules 280 may be supported by the rear frame 326. Light emitted from the light source module 270 supported by the sub-frame 406 enters a lateral side of the light guide plate 220 in the X direction, and light emitted from the light source module 280 supported by the rear frame 326 enters a lateral side of the light guide plate 220 in the Y direction. That is, the traveling direction of the light emitted from the light source module 270 supported by the sub-frame 406 is perpendicular to the traveling direction of the light emitted from the light source module 280 supported by the rear frame 326.

As the light source modules 270 and 280 are operated, heat is generated from the respective light source modules 270 and 280. In this case, the light source modules 270 and 280 are respectively supported by the sub-frame 406 and the rear frame 326, so that the temperature of the sub-frame 406 and rear frame 326 is higher than that of the front frame 316.

According to this exemplary embodiment, the thermal expansivity of the sub-frame 406 and rear frame 325 where the light source modules 270 and 280 are respectively supported is smaller than that of the front frame 316. Here, the sub-frame 406 and the rear frame 326 may have substantially the same thermal expansivity, or may be different in the thermal expansivity from each other within a preset range in consideration of the characteristics of the light source modules 270 and 280, but is not limited thereto.

With this, it is possible to prevent an edge area of the display apparatus 8 from being twisted or bent in the Y or −Y direction with respect to a center area of the display apparatus 8.

As apparent from the foregoing exemplary embodiments, the light source module is supported by at least one of the rear frame and the sub-frame so as to be disposed at the rear of the display panel. Further, one of the rear frame and the sub-frame, where the light source module is supported, has smaller thermal expansivity than the others of the front frame, the rear frame and the sub-frame, where the light source module is not supported. Thus, it is possible to prevent the display apparatus from being deformed by heat of the light source module.

Also, if the plural light source modules are supported by only one of the sub-frame and the second frame, the frame supporting the light source module has smaller thermal expansivity than the other frame which does not support the light source module. Further, the thermal expansivity of the other frame which does not support the light source module is smaller than the thermal expansivity of the first frame. This is because the first frame has a large contact area with the exterior and is relatively advantageous to radiate heat.

On the other hand, if the plural light source modules are respectively supported by the sub-frame and the second frame, the sub-frame and the second frame have smaller thermal expansivity than the first frame. Throughout the foregoing descriptions, “support” means direct contact or indirect contact.

Although a few exemplary embodiments have been shown and described, it will be appreciated by those skilled in the art that changes may be made in these exemplary embodiments without departing from the principles and spirit of the inventive concept, the scope of which is defined in the appended claims and their equivalents.

What is claimed is:

1. A display apparatus comprising:
a display panel which displays an image based on an image signal;
a main frame which comprises a first frame which supports a front side of the display panel and a second frame which supports a rear side of the display panel;
a sub-frame which is coupled to the main frame; and
a light source module which is disposed behind the display panel and provides light to the display panel,
wherein at least one of the first frame, the second frame and the sub-frame, where the light source module is supported, has smaller thermal expansivity than the others of the first frame, the second frame and the sub-frame, where the light source module is not supported.

2. The display apparatus of claim 1, wherein the first frame, the second frame and the sub-frame are thermally deformed to correspond to each other by heat from the light source module while the light source module operates.

3. The display apparatus of claim 1, wherein the sub-frame is accommodated in, and interposed between, the first frame and the second frame.

4. The display apparatus of claim 3, wherein the sub-frame is supported by at least one of the first frame and the second frame.

5. The display apparatus of claim 4, wherein the sub-frame has a bar shape which has a polygonal cross-section, and comprises a first surface which contacts the first frame, a second surface reverse to the first surface and which contacts the second frame, and a third surface interposed between the first surface and the second surface and which contacts the light source module.

6. The display apparatus of claim 5, wherein at least one of the first surface and the second surface of the sub frame is coupled to at least one of the first frame and the second frame by at least one of a fastener, a double-sided tape and an adhesive.

7. The display apparatus of claim 1, wherein the first frame has a rectangular shape which extends along four edges of the display panel, and the sub-frame has a bar shape which extends along the first frame.

8. The display apparatus of claim 1, wherein if the light source modules are supported by one of the sub-frame and the second frame, the one of the sub-frame and the second frame supporting the light source module has smaller thermal expansivity than the other of the sub-frame and the second frame which does not support the light source module, and the thermal expansivity of the other one of the sub-frame and the second frame which does not support the light source module is smaller than the thermal expansivity of the first frame.

9. The display apparatus of claim 1, wherein if the light source modules are respectively supported by the sub-frame and the second frame, the sub-frame and the second frame have smaller thermal expansivity than the first frame.

10. The display apparatus of claim 1, wherein the light source module comprises a light source; and a light source board which has one surface on which the light source is mounted and another surface supported by at least one of the sub-frame and the second frame.

11. The display apparatus of claim 1, further comprising:
a base supported on a predetermined installation surface; and
a stand coupled to the base and supporting the main frame against the base.

12. The display apparatus of claim 11, further comprising:
an image signal receiver which receives an image signal;
an image signal processor which processes the image signal received by the image signal receiver to be displayed on the display panel; and
a light source driver which drives the light source module,
wherein at least one of the light source driver, the image signal receiver, and the image signal processor is coupled to at least one of the main frame and the base.
